(19) United States
(12) Patent Application Publication
(10) Pub. No.: US 2017/0211293 A1
(43) Pub. Date: Jul. 27, 2017

(54) Enhanced Security Ring for Advertising Purposes

(71) Applicant: Alon Golan, Margate, FL (US)

(72) Inventor: Alon Golan, Margate, FL (US)

(21) Appl. No.: 15/005,373

(22) Filed: Jan. 25, 2016

(51) Int. Cl. E05B 17/20; E05B 15/16; E05B 15/02; G09F 23/00

(52) U.S. Cl. CPC E05B 17/2003; G09F 23/00; E05B 15/1614; E05B 15/02; E05B 2015/1628

(57) ABSTRACT

This invention was a long time coming, locksmith sticker spam is on every commercial door, making it hard on business owners to know who genuinely serviced their lock.

This invention is a metal security ring with a plate on top, on the plate, the locksmith's name and phone number appears.

The manufacturing of the Enhanced Security Ring requires a mold, a flat circle metal piece is placed on the mold and then pressed to create its shape.

The Enhanced Security Ring has 2 main purposes:
1. Protection against break in: The security ring surrounds the lock and prevents an intruder from grabbing the lock and spinning to break connecting pins.

### BACKGROUND OF THIS INVENTION

The inventor, owner of a locksmith company has been developing his business and growing it, working on location, replacing and repairing locks.

When leaving a customer's location it is acceptable that a service professional leaves a sticker by the lock installed/repaired so when time comes for lock maintenance or other type of service the customer may need, he will know to get in touch with the original service provider.

It comes to notice, the sticker which the service professional places, is replaced with another, also, checking the neighbor's doors, they all have the same spammer locksmith's stickers on.

Speaking to customers, they do not know who places the sticker on their storefronts nor do they authorize the placement of those stickers.

The only provider they authorize is the only locksmith servicing their lock.

A solution is now being developed for this growing issue, a permanent, on lock advertising that will have a lock protection advantage as well.

This invention is designed to protect providers like authorized locksmiths and also home and business owners in two ways:
1. Protect home/business owners.
2. Protecting the lock against forced entry.

### SUMMARY OF THIS INVENTION

This invention is a round metal piece with flat metal plate on top presenting phone number and logo of service provider, the invention was designed to fit with all types and sizes of a “Mortice Cylinder” lock (U.S. Pat. No. 2,194,244 A), mostly used on commercial doors.

This invention relates to a growing security issue in the locksmith industry across the USA.

This invention will solve the locksmith sticker advertising/solicitation issue, today, many locksmiths will place a sticker on a door, another locksmith will take off the competitor's sticker and place his own sticker, and the property owner is confused and never knows whether the person on the sticker is indeed the locksmith who serviced his lock.

With this Invention, only the locksmith who serviced the lock will be able to install the Enhanced Security Ring.

With this invention both parties will be protected, home/business owners and authorized service providers:
1. Protecting home/business owners by having a permanent reminder of who their authorized service provider is, saving the aggravation of un-knowingly calling the wrong (may also be non-qualified) service provider and them being able to access their home/business.
2. Protecting the lock against forced entry, the Enhanced Security Ring surrounds the lock cylinder, with the Enhanced Security Ring, the lock cannot be grabbed by any tool, if a tool grabs the Enhanced Security Ring, the Enhanced Security Ring will loosely spin along with the tool used—no harm to the lock.

### STATEMENT OF INVENTION

This invention is the solution of the locksmith sticker clutter on doors across the USA.

The Enhanced Security Plate is an esthetic stainless steel, weatherproof, round and has a flat oval extension for information on top and looks as if it is a part of the lock.

This invention can only be installed with home/business owner's permission, opposed to the stickers, which are glued on doors in a non-professional manner and without permission.

This invention will contain service provider phone number and name or information and could only be taken down by removing the lock itself, therefore the client will always know who originally serviced his lock.

The Enhanced Security Plate keeps the lock in place and prevents break-ins; the lock cannot be grabbed by any tool, if a tool grabs the Enhanced Security Ring, the Enhanced Security Ring will loosely spin along with the tool used.

In the drawing:

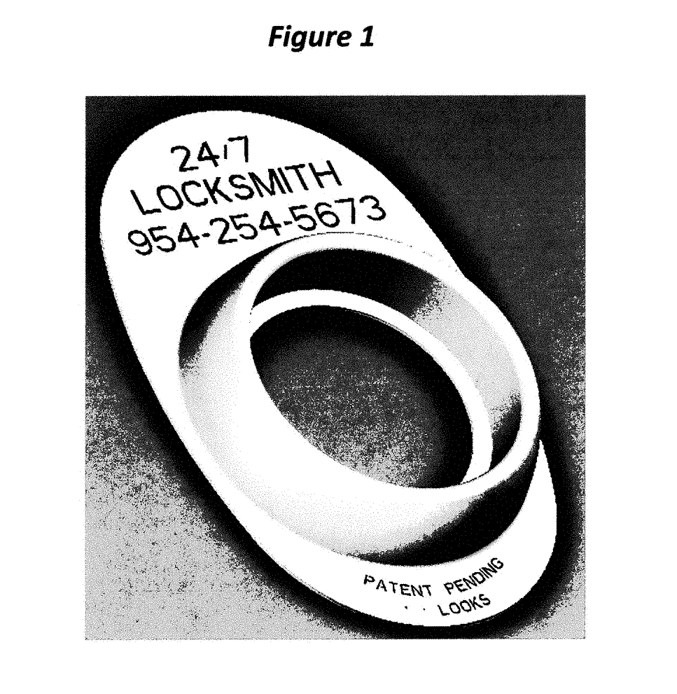

FIG. 1: Security plate presenting phone number and information.

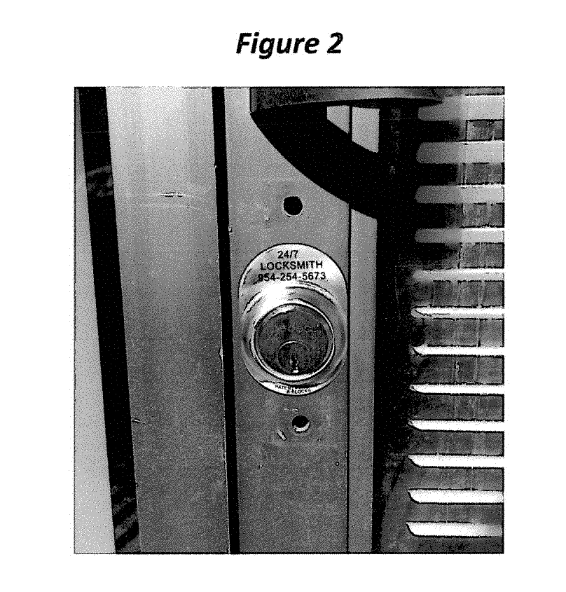

FIG. 2: Security plate prototype installed on our office door.

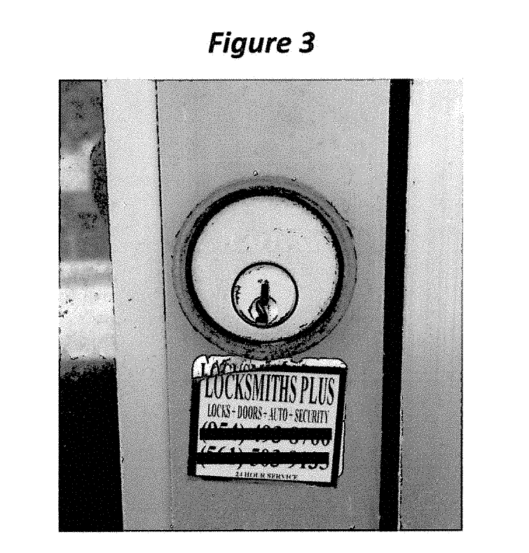

FIG. 3: Spam stickers of locksmith.

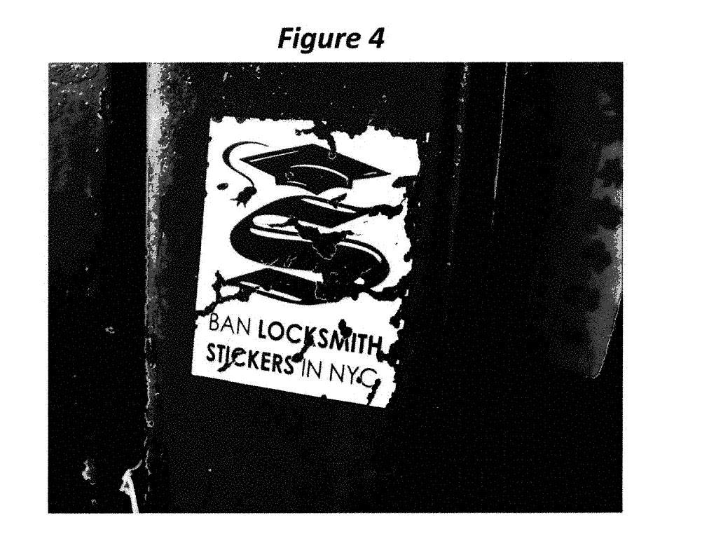

FIG. 4: One of home/business owners attempts to stop the sticker spam.

### DESCRIPTION OF INVENTION

This invention is a round metal piece with flat plate on top made out of stainless steel presenting phone number and logo of service provider, the invention was designed to fit with all types and sizes of a “Mortice Cylinder” lock (U.S. Pat. No. 2,194,244A), mostly used on commercial doors.

The invention is made for security and marketing purposes.

Process of manufacturing requires a mold, a flat metal piece is then stamped into a circular and flat shape at once giving it its shape (FIG. 1) the back of the piece remains hollow.

The piece is then screen printed on with information such as phone number and name of company.

This invention requires installation as follows:

The mortice cylinder lock (U.S. Pat. No. 2,194,244 A) is un-installed from the door lock mechanism, then, the mortice cylinder lock is placed inside the Enhanced Security Ring and both pieces re-installed together back into door lock mechanism and look and act as if they are one piece.

The Enhanced Security Ring can only be removed by un-installing the mortice cylinder.

1. The invention is a round metal piece with flat metal plate on top presenting phone number and logo of service provider (FIG. 1), the invention is designed to fit all types and sizes of a “Mortice Cylinder” lock (U.S. Pat. No. 2,194,244 A), mostly used on commercial doors.

2. This invention is for the purpose of securing a lock against break-ins and advertising the service provider at once.

3. The Enhanced Metal Plate for Security Purposes was mainly invented to fight locksmith sticker spam/solicitations and fills its purpose with a smarter, cleaner, more esthetic look to the client's door.

4. Issues this invention will solve: Locksmiths will place a sticker on a door, another locksmith will take off the competitor's sticker and place his own sticker, and the property owner is confused and never knows whether the person on the sticker is indeed the locksmith who serviced his lock.

5. With this Invention, only the locksmith who serviced the lock will be able to install the Enhanced Security Ring.

6. With this invention both parties will be protected, home/business owners and authorized service providers:
6.1. Protecting home/business owners by having a permanent reminder of who their authorized service provider is, saving the aggravation of un-knowingly calling the wrong (may also be non-qualified) service provider and them being able to access their home/business.
6.2. Protecting the lock against forced entry, the Enhanced Security Ring surrounds the lock cylinder, with the Enhanced Security Ring, the lock cannot be grabbed by any tool, if a tool grabs the Enhanced Security Ring, the Enhanced Security Ring will loosely spin along with the tool used—no harm to the lock.

7. The Enhanced Security Ring is an esthetic stainless steel, weatherproof, round and has a flat oval extension for information on top and looks as if it is a part of the lock.

8. This invention can only be installed with home/business owner's permission, opposed to the stickers, which are glued on doors in a non-professional manner and without permission.

9. This invention will contain service provider phone number and name or information and could only be taken down by removing the lock itself, therefore the client will always know who originally serviced his lock.

10. This invention, a round metal piece with flat plate on top made out of stainless steel presenting phone number and logo of service provider, the invention was designed to fit with all types and sizes of a “Mortice Cylinder” lock (U.S. Pat. No. 2,194,244 A), mostly used on commercial doors.

11. The invention is made for security and marketing purposes.

12. Process of manufacturing requires a mold, a flat metal piece is then stamped into a circular and flat shape at once giving it its shape (FIG. 1) the back of the piece remains hollow.

13. The piece is then screen printed on with information such as phone number and name of company.

14. This invention requires installation as follows:
14.1. The mortice cylinder lock (U.S. Pat. No. 2,194,244 A) is un-installed from the door lock mechanism.
14.2. The mortice cylinder lock is placed inside the Enhanced Security Ring.
14.3. The mortice cylinder lock and the Enhanced Security Ring pieces are re-installed together back into door lock mechanism and look and act as if they are one piece.

15. The Enhanced Security Ring can only be removed by un-installing the mortice cylinder.
